(19) United States
(12) Patent Application Publication
(10) Pub. No.: US 2005/0236790 A1
(43) Pub. Date: Oct. 27, 2005

(54) Wheeled arrangement

(76) Inventor: William Shane Carter, Mt. Martins (AU)

Correspondence Address: MICHAEL BEST & FRIEDRICH, LLP, 100 E WISCONSIN AVENUE, MILWAUKEE, WI, 53202, US

(21) Appl. No.: 10/509,049

(22) PCT Filed: Mar. 21, 2003
(86) PCT No.: PCT/AU03/00343

§ 371 Date: May 23, 2005

(30) Foreign Application Priority Data
Mar. 22, 2002 (AU) PS 1303

(51) Int. Cl. B62B 1/00

(52) U.S. Cl. 280/79.11

(57) ABSTRACT

A wheel arrangement (10) having a first support arrangement, a second support arrangement a fixed framework member and a moveable support member having a substrate contacting wheel, the first and second support arrangements are moveable with respect to the fixed framework member, the first support arrangement and the second support arrangement are located substantially transversely to each other and cooperatively interact with the fixed framework member whilst permitting the moveable support member to move with respect to the fixed framework member, so that movement of the first and second support arrangements permits the substrate contacting wheel to move with respect to the fixed framework member.

The present invention relates generally to a wheel arrangement and in particular to an adjustable wheel arrangement. More particularly, the present invention relates to a wheel arrangement suitable for use in adjusting the height of an appliance or a piece of equipment to which the wheel arrangement is fitted, and particularly to an adjustable castor wheel arrangement. Even more particularly, the present invention relates to an adjustable castor wheel arrangement that is capable of swiveling through 360 degrees for use with a wheeled hoist or similar, particularly a wheeled hoist for supporting a motor vehicle or similar, such as for example, a hoist of the type that allows the hoist to be moved when the wheel arrangement is in one configuration, such as an extended configuration, and provides a stable base for the hoist when the wheel arrangement is in another configuration, such as a retracted configuration, by preventing movement of the hoist owing to a part of the hoist, particularly a chassis member of the hoist, resting directly upon the floor of a workshop or similar. The present invention finds particular application as the castor wheels of a mobile motor vehicle hoist capable of swiveling through 360 degrees used to lift and move motor vehicles, particularly heavy motor vehicles, around a workshop or similar in which the castor wheels when in a relatively lowered position raise the height of the hoist allowing sufficient ground clearance for the hoist to be wheeled or otherwise manoeuvred around the workshop so that when the hoist is located in the desired position the wheels are raised or retracted to lower the hoist so that the hoist rests directly upon the floor or on ground level of the workshop or factory thereby providing a stable support for the load carried by the hoist, without the possibility of the hoist undergoing any unwanted movement over the surface of the floor.

Although the present invention will be described with particular reference to one form of the wheel assembly and to different forms of the wheel arrangement for use with a mobile motor vehicle hoist, it is to be noted that the scope of the present invention is not limited to the described embodiments or arrangements but rather the scope of the present invention is more extensive so as to include other assemblies, arrangements and forms of the wheel arrangement or devices containing the various wheel arrangements, other means for adjusting the position of the wheel arrangements including the wheels, and the use of the wheels in applications other than the hoist as described herein.

There is a need for motor vehicles and other relatively heavy loads to be moved round a workshop, factory or similar. Currently, trolleys, hoists or similar mobile conveyances are used to transport the motor vehicle or other load from one location within the workshop to another location. However, with many of the existing hoists, once the hoist is loaded it must remain static, ie., there is no provision for moving the hoist when loaded.

With still other hoists, the height of the hoist is adjustable but the hoist is stationary, ie., the load can be lifted but not moved from one location to another. Whilst still other hoists are unstable when moved about or when static since the load cannot be evenly balanced or the support for the load is too small to adequately hold the motor vehicle in a stable condition. Thus, there is a need for a hoist which is adjustable in height and which can move from one location to another when fully loaded, particularly whilst maintaining the load in a stable condition both whilst the hoist is being moved and when stationary, particularly when stationary in a raised position.

Existing hoists which can be moved when loaded suffer from some drawbacks and disadvantages.

One problem is that the hoists, even when in the fully lowered position, are still too high to fit underneath a motor vehicle so that the motor vehicle can be raised to a more convenient working height when the hoist is raised. One reason for this is that if the wheels are strong enough to support the vehicle, they must be of a large size which often is too large a size to fit under the vehicle. This large size is often a result of the construction of the wheel and the mechanism, particularly a castor wheel mechanism, for supporting the wheels.

Other problems with such hoists are that when the hoist is in the raised or partially raised position the load is unstable so there is a tendency for the hoist to topple sideways which can damage the load and/or cause injury to nearby workmen even when the hoist is stationary.

Further, as the hoist is provided with wheels for mobility there is a tendency for the hoist when in the raised position under load to undergo unwanted movement, such as for example, to slip or slide sideways onto the floor, or to be unstable when supported by the wheels alone. Attempts in the past have been made to make the hoist more stable when in the storage position or similar with the hoist raised. Such attempts include having wheels which can be retracted within the body of the hoist to lessen the possibility of accidental slippage due to contact of the wheels with the floor or similar. However, existing retractable wheels have suffered from one or more problems. One problem is that the adjustment mechanism allowing for the retraction of the wheels is not sufficiently strong to support the weight on the hoist, particularly if large or heavy loads such as commercial motor vehicles including agricultural vehicles, utilities or similar work, commercial or industrial vehicles are loaded onto the hoists.

Other problems of adjustable wheels include mechanisms that jam or are difficult to operate either due to the method of their construction or to the relatively light weight materials from which they are made so that the wheels have a tendency to bend, distort or the like under load preventing them from operating effectively or safely.

Another problem relates to the strength of the wheels themselves and the method of attaching the wheels to the hoist. In many cases owing to the need for the wheels to be able to swivel through 360°, the point at which the wheels are attached to the hoist is the weakest part of the assembly which leads to accelerated wear and premature breakage or failure of either the wheels or the associated linkages. Thus, there is a need for a method and arrangement of connecting castor type wheels to the hoist which results in stronger more durable wheel assemblies.

Still further problems relate to the wheels not being able to freely rotate through 360 degrees when the loaded hoist is being maneuvered around a workshop fully laden. In these cases, the swiveling movement of the wheels is limited again either due to their method of construction or to the use of light weight materials which are not sufficiently strong to support the wheels whilst allowing free rotation through 360° depending upon needs.

Thus, there is a need for a compact, workable, rugged wheel assembly and/or wheel arrangement, particularly a castor wheel arrangement, that is adjustable in height and allows a full 360 degrees swiveling movement, and that is capable of being attached to a piece of equipment, such as a mobile motor vehicle hoist, allowing the hoist to work effectively under heavy loads. Moreover, there is a need for a wheeled assembly that is attached through or to the side of the hoist so as to increase the strength of the wheel arrangement and to simplify and strengthen the mechanism for changing the height of the wheel as well as having a stronger connection to the remainder of the assembly. Further, there is a need for a wheel assembly that is sufficiently strong to support the weight of a heavy load upon the hoist, yet small enough to fit under the vehicle when the vehicle is resting on normal road wheels or similar.

Therefore, it is one aim of the present invention to provide a wheel arrangement, particularly a castor wheel arrangement, and more particularly a castor wheel arrangement adapted for use with a mobile hoist, which is compact, rugged and easily operated so as to be adjustable between two positions in which in one position the hoist is movable by being supported by the wheels whereas in another position the hoist is prevented from unwanted movement by being supported by its own structure and in which the wheel assembly is stronger and more durable.

According to one aspect of the present invention there is provided an adjustable wheel arrangement, particularly adapted for use with mobile load carrying equipment to support a load on a substrate, said wheel arrangement including an operating member movable between a first position and a second position, a wheel carrying assembly movable between a first position and a second position and a reinforcing member connected to the wheel carrying assembly but not connected directly to the operating member wherein movement of the operating member in one direction causes corresponding movement of the wheel carrying assembly and reinforcing member in a first direction so that the wheel carrying assembly adopts a first position and movement of the operating member in another direction causes corresponding movement of the wheel carrying assembly and the reinforcing member in a second direction to adopt a second position such that the reinforcing member limits the amount of movement in the first and second directions between the first and second positions and determines the first and second positions whilst assisting in maintaining the wheel carrying assembly in the first and in the second positions whereby in one position the wheel arrangement contacts the substrate to support the load and in another position the wheel arrangement is not the sole support of the load on the substrate.

According to another aspect of the present invention, there is provided a wheel assembly having a first support arrangement, a second support arrangement, a moveable mounting member or means provided with a substrate contacting wheel and a fixed framework member, characterised in that said first and second support arrangements are moveable with respect to the fixed framework member, the first support arrangement and the second support arrangement are located substantially tranversely to each other and cooperatively interact with the fixed framework member whilst permitting the moveable mounting member to move with respect to the fixed framework member so that the movement of the first and second support arrangements permits the substrate contacting wheel to move with respect to the fixed framework member.

Typically, the mobile load carrying equipment is a mobile hoist. More typically, the mobile hoist is for carrying a motor vehicle or similar load. Even more typically, the mobile hoist is a multi position hoist having a scissors lift mechanism or parallelogram lift mechanism for lifting the load using the hoist. More typically, the hoist is provided with a locking means for locking the hoist in the raised position. Even more typically, the load support or platform of the hoist raises and lowers substantially parallel to the chassis or chassis members of the hoist.

Typically, the operating member is an operating lever. More typically, the operating lever is fixedly connected to a rotating shaft. Even more typically, the operating lever and shaft are fixedly connected to an elongate bracket, yoke or similar.

Typically, the operating member rotates in use. More typically, the operating lever rotates in a first direction to lower the wheel arrangement and rotates in the second direction to raise the wheel arrangement. Even more typically, the first and second directions of movement are in opposite directions to each other. Even more typically, the operating lever is connected to a part of the wheel support or wheel carrying assembly.

Typically, the wheel carrying assembly includes a wheel carrying member to which the operating member is connected. More typically, the wheel carrying member is a shaft, axle, pin or similar.

Typically, the wheel carrying assembly includes a wheel carrying member. More typically, the assembly is a castor assembly, preferably having a swiveling castor wheel subassembly. Even more typically, the castor wheel assembly is provided with roller bearings or similar allowing swivelling movement of the wheel or wheel assembly with respect to the remainder of the wheel carrying assembly.

Typically, the wheel carrying assembly is movable between a first position in which the castor wheel is in a relatively lowered position and a second position in which the castor wheel is in a relatively raised position.

Typically, the reinforcing member is a plate. More typically, the plate is provided with a hinge member, such as for example, a tongue. Even more typically, the tongue is connected to or is received in a yoke, saddle or similar fixedly connected to the chassis of the hoist. Typically, the reinforcing member is a reinforcing plate fixedly connected to a pin, shaft or similar.

Typically, the wheel arrangement of the present invention is fixed to or mounted to the side of the hoist. More typically, to a lengthwise extending member extending along one side of the hoist. Even more typically, the wheel arrangement is provided with a main framework member which is fixedly connected at one side to the end of the lengthwise extending member by suitable fastening means. Even more typically, the main framework member is a substantially U-shaped yoke. The U-shaped yoke is provided with downwardly depending arms to which the wheel arrangement is connected to suspend the wheel to increase the strength of the wheel arrangement.

According to another aspect of the present invention, there is provided a wheel assembly including:
a fixed support member or framework member provided with a first pathway and a second pathway;
a mounting means provided with a substrate contacting wheel moveable with respect to the mounting means, said mounting means provided with a first travel means for movement along the first pathway of the fixed or stationary member and a second travel means for movement along the second pathway of the fixed or stationary member, said mounting means and wheel being moveable as a unit with respect to the fixed or stationary member;
wherein the first travel means and the second travel means are arranged to lie in two different planes, such that movement of the first travel means along the first pathway and movement of the second travel means along the second pathway are in unison with each other so as to facilitate movement of the mounting means with respect to the fixed or stationary member, thereby allowing the wheel to move with respect to the stationary member whilst allowing the first and second travel means to remain in contact with the stationary member.

Typically, the wheel assembly is fixedly connected to the wheel carrying member. More typically, there are four almost identical wheel assemblies connected to the hoist at either corner of the hoist.

Typically, the fixed framework or stationary member is a substantially U-shaped bracket or yoke fixedly connected to the wheel carrying member for movement therewith to move the wheel assembly between the two configurations. More typically, the U-shaped bracket or yoke includes a deck and two downwardly depending side support arms or side skirts. Even more typically, the side support arms or side skirts are connected to the wheel carrying member.

Typically, the deck is provided with a central aperture. More typically, the central aperture is a circular aperture. Even more typically, the central aperture is provided with a flanged edge or rebated edge around the circumference of the aperture. Even more typically, the flanged or rebated edge is the first pathway. Even more typically, the first pathway is a circular race or track.

Typically, the circular aperture of the deck is provided with an undersurface. More typically, there is an undersurface around the edge of the circular aperture. Even more typically, the lower surface to and around the edge of the aperture forms the second pathway. Even more typically, the second pathway is a race or a track.

Typically, the mounting member or means is a U-shaped bracket or yoke. More typically, the U-shaped bracket has a web portion and two downwardly depending side arms or supports. Even more typically, the web portion is planar and extends substantially horizontally. Even more typically, the side arms are planar and extend substantially vertically. Even more typically, the side arms are substantially triangular in shape.

Typically, the wheel is connected between the triangular side arms for rotational movement with respect to the U-shaped bracket.

Typically, the mounting member is a tubular member, preferably a circular tubular member or ring, more preferably a circular tubular member or ring having a cut-out or segment of the rim missing. Even more typically, the wheel is located in the cut-out or in the space from which the segment is removed. Even more typically, the downwardly depending triangular side arms are connected to the edges of the cut-out section or gap in the ring or tube so that the wheel is held securely to rotate in the gap or space between the edges of the cut-out. This arrangement allows the wheel arrangement to be more compact since the majority of the mounting member is located below the top of the wheel. Even more typically, 90% of the height of the mounting member or means is lower than the top surface of the wheel.

Typically, the first travel means includes roller means, such as roller wheels, roller bearings, ball bearings or similar. More typically, the roller wheels are mounted substantially horizontally. Even more typically, the roller wheels etc rotate within the flanged rebate around the circumference of the aperture in the deck. Typically, there are any number of horizontal roller wheels, preferably seven such wheels.

Typically, the second travel means includes roller means or rolling means, such as roller wheels, roller bearings, ball bearings or similar. More typically, the roller wheels etc are mounted substantially vertically. Even more typically, the roller wheels travel round the edge of the aperture at the underside of the deck.

Typically, the mounting means is provided with a cover for releasably securing to the web of the U-shaped bracket forming the mounting means. More typically, the cover is a circular cover plate. Even more typically, the cover plate is located on one side of the deck of the stationary member, preferably the upper side, whilst the web of the mounting means is located at the other side of the deck, preferably the underside of the deck. More typically, the cover plate is clamped to the mounting means to locate and maintain the two sets of roller wheels in the respective tracks so as to allow the mounting means and wheels to rotate or swivel with respect to the stationary member thereby allowing 360° movement of the hoist over the floor whilst strongly connecting the wheel assembly to the hoist.

Typically, the cover plate is connected to the web by adjustable fasteners. More typically, the fasteners also serve as axles, preferably stub axles, for the first set of roller wheels mounted horizontally to run in the flanged rebate of the deck.

Typically, the position of the first set of roller wheels corresponds to the position of the second set of roller wheels. Typically, the two sets of roller wheels are aligned adjacent each other to rotate in their respective tracks at or about the same point of contact.

The present invention will now be described by way of example with reference to the accompanying drawings in which:

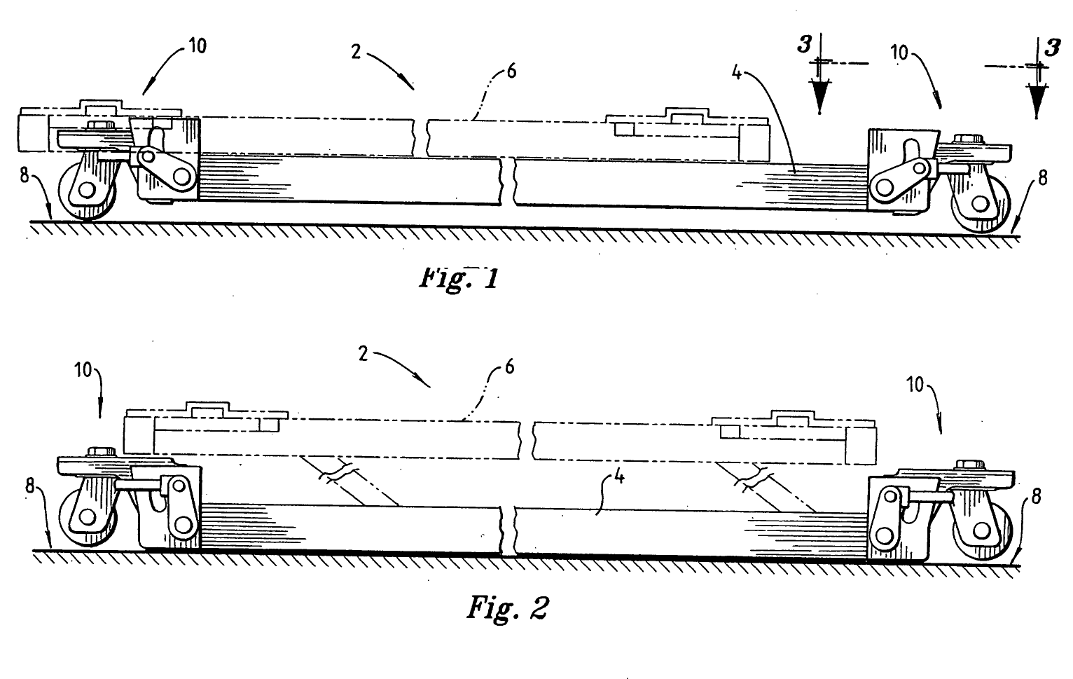

FIG. 1 is a side elevation view of a hoist having one form of the wheel arrangement of the present invention when the hoist is in the raised position with the wheels in the relatively lowered position allowing movement of the hoist on the wheels over the surface of a suitable substrate.

FIG. 2 is a side view of the hoist of FIG. 1 when in a lowered position with the wheels in a relatively raised position allowing the hoist to rest stably on the substrate.

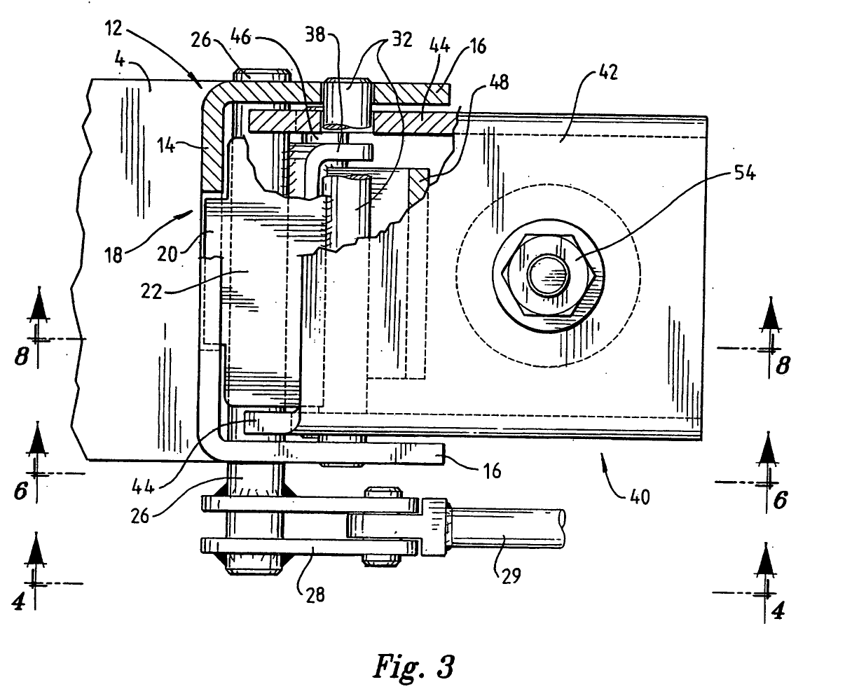

FIG. 3 is a partial top plan view along the line 3 to 3 of FIG. 1 and a partial fragmentary view showing one form of the wheel carrying assembly.

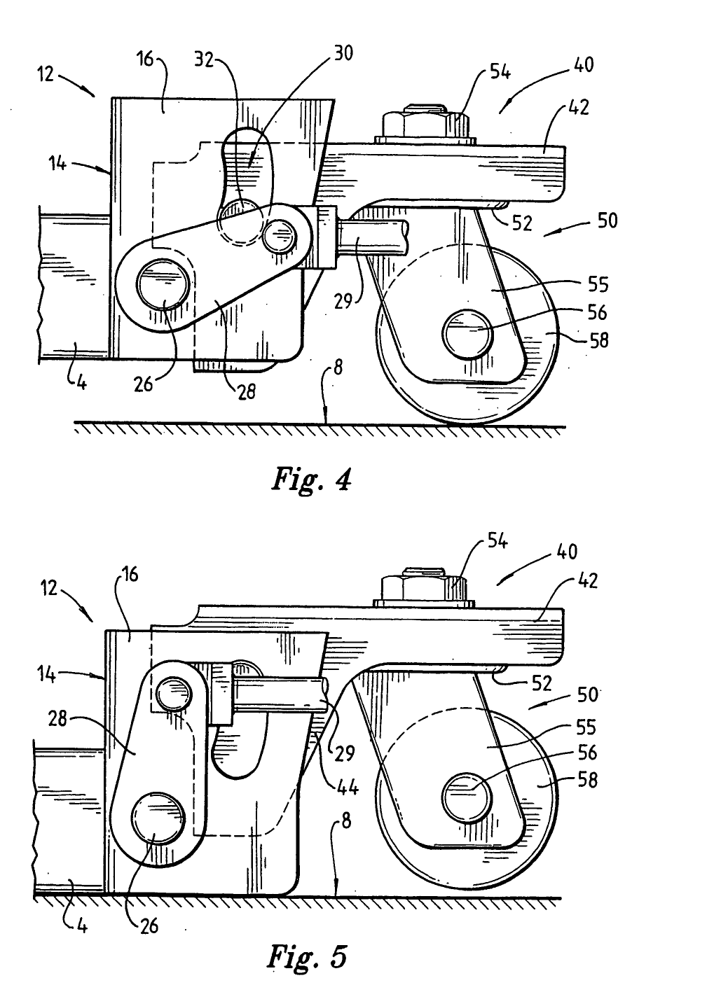

FIG. 4 is a more detailed side elevation view along the line 4 to 4 of FIG. 3 of the wheel arrangement of the present invention shown in FIG. 3 when the wheel is in the relatively lowered position thereby raising the hoist.

FIG. 5 is a similar view to the view of FIG. 4 when the wheel is in the relatively raised position thereby lowering the hoist to rest securely on a suitable substrate.

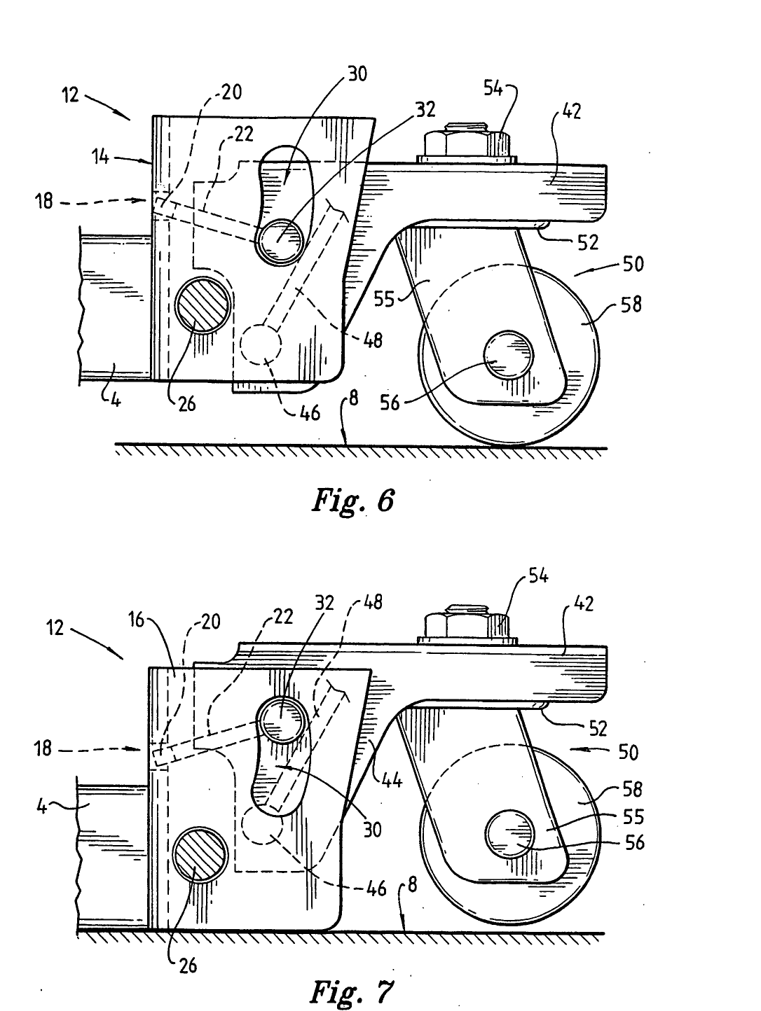

FIG. 6 is a sectional view along the line 6 to 6 of FIG. 3 when the wheel is lowered and the hoist raised.

FIG. 7 is a sectional view similar to that of FIG. 6 but showing the wheel in a raised position and the hoist lowered.

FIG. 8 is a sectional view along the line 8 to 8 of FIG. 3 showing the wheel lowered and the hoist raised.

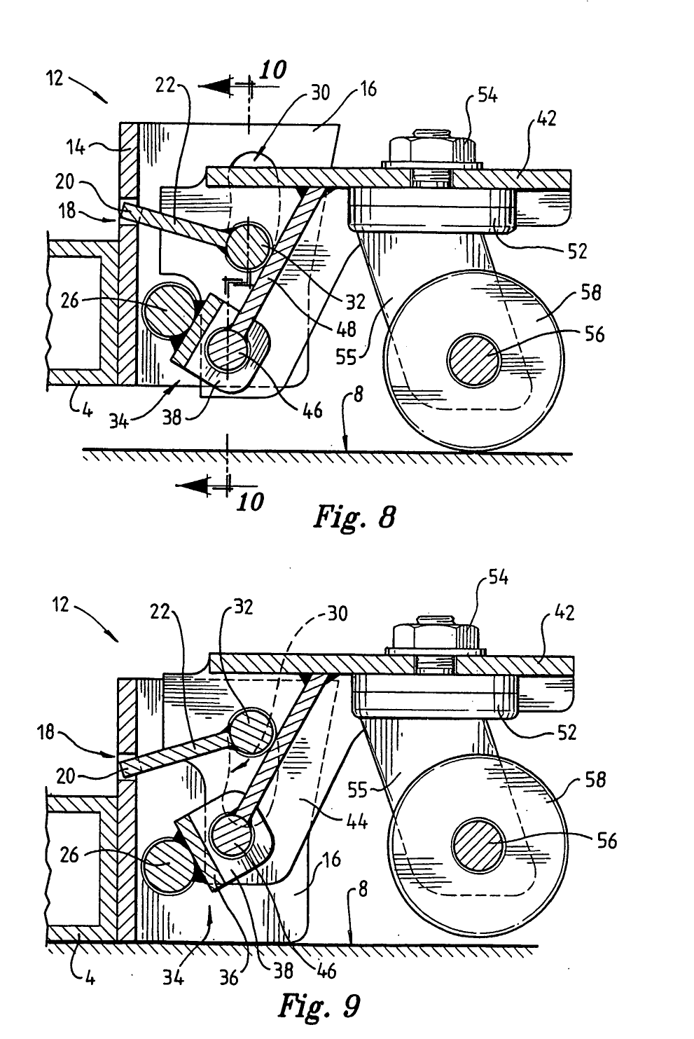

FIG. 9 is a sectional view similar to that of FIG. 8 but showing the wheel raised and the hoist lowered.

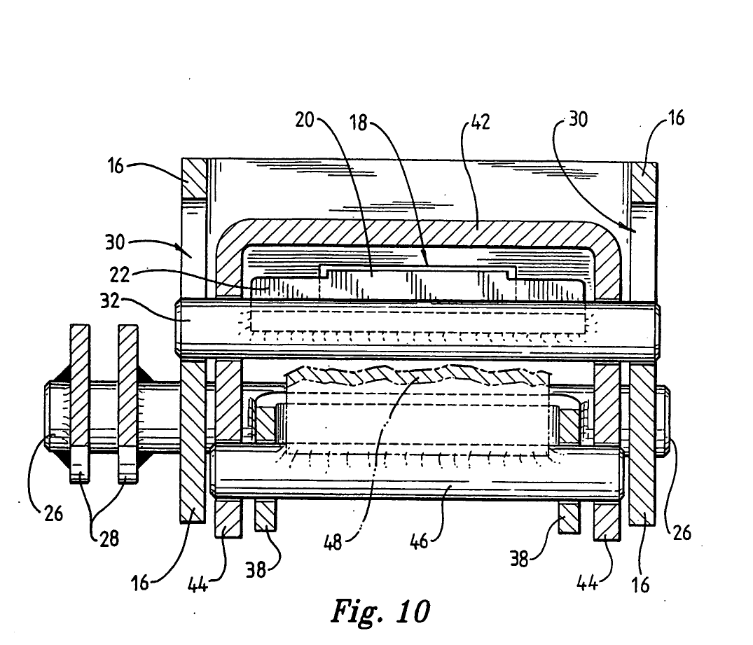

FIG. 10 is a sectional view taken along the line 10 to 10 of FIG. 8 showing the internal arrangement of some of the components forming the wheel arrangement.

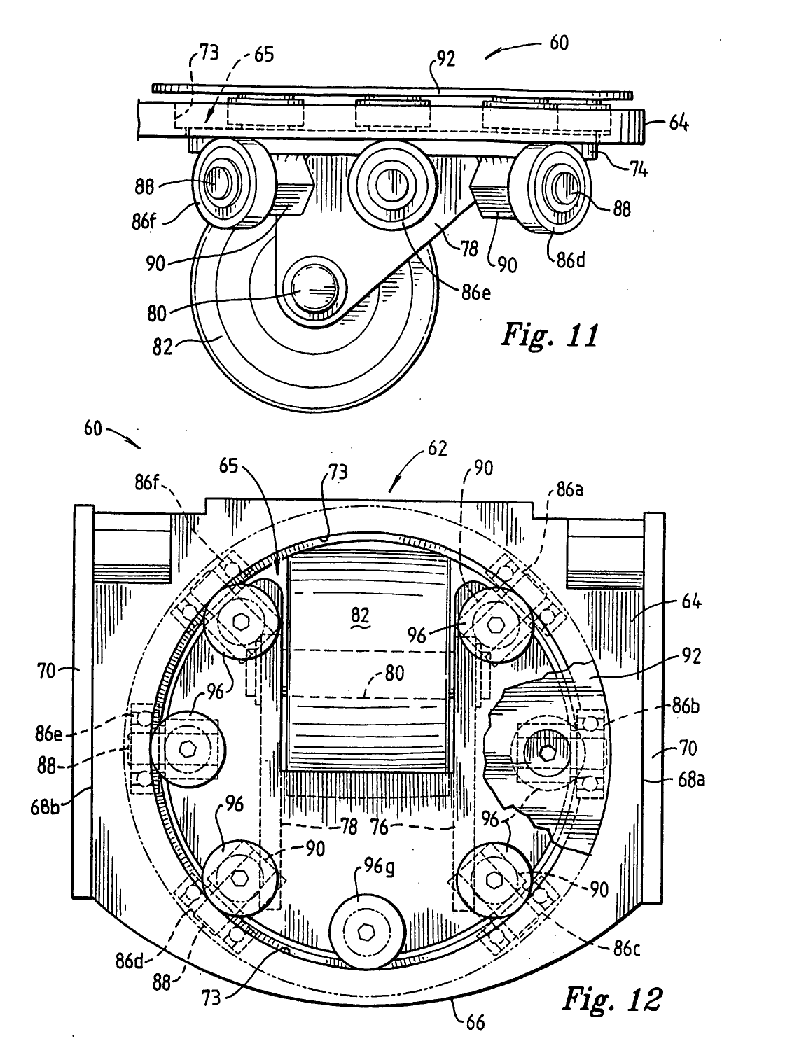

FIG. 11 is a side elevation view of an alternative form of the wheel arrangement of the present invention shown in isolation.

FIG. 12 is a top plan view of the form of the wheel arrangement of FIG. 11.

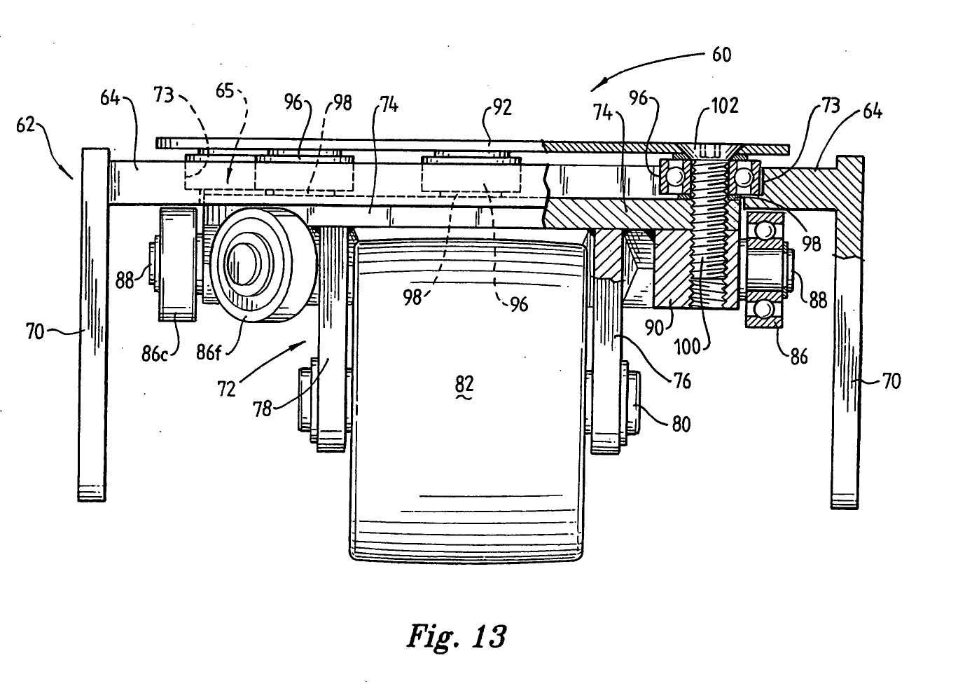

FIG. 13 is a partial side elevation view and a partial cross section view of the form of the wheel arrangement of FIGS. 11 and 12 but shown from a different aspect of rotation than shown in FIG. 11.

One form of the hoist which is generally denoted as 2 is shown in FIGS. 1 and 2 of the drawings and has one form of the wheel arrangement of the present invention. This form of the hoist is generally provided with a raisable parallelogram mechanism for lifting a motor vehicle (not shown) located on top of the hoist, such as for example, on the load platform of the hoist. Generally, hoist 2 comprises a substantially rectangular lower chassis of which one longitudinal chassis member 4 is shown and an upper platform 6 of generally rectangular configuration upon which the load to be lifted, typically a motor vehicle, is located for support. In use, upper platform 6 is raised above chassis 4 by a suitable scissors arrangement, parallelogram linkage or similar to support the load so that hoist 2 is free to be pushed or otherwise manoeuvred over the floor 8 of a workshop or similar to move the load when in a raised position clear of the floor using the swivelling wheel arrangement of the present invention. The raising and lowering of the load upon hoist 2 is independent of the adjustment of the wheel arrangement and can be effected in a variety of ways. One particular way is through a hydraulic system. Other ways include an electric motor. Any convenient raising and lowering system can be used.

A wheel arrangement generally denoted as 10 is provided at each corner of the generally rectangular hoist 2 by being adjustably connected to either end of the two lower chassis members 4 making up the chassis of hoist 2. When the wheel arrangement 10 is in the lowered position or extended position as shown in FIG. 1 the lower chassis member 4 is raised clear of the floor 8 upon which the wheels rest allowing movement of the hoist 2 over the floor 8 to locate the load at a predetermined position. When the wheel arrangement 10 is in the raised or retracted position, as shown in FIG. 2, the lower chassis member 4 is in effect lowered so as to rest upon the floor 8 thereby preventing the hoist from moving over the floor from one position to another position and keeping the load upon the hoist in a stable manner since the wheels of the wheel assembly are not in contact with floor 8. Thus, when the hoist is in the raised position the wheels are in the relatively lowered or extended position and when the hoist is in the lowered position the wheels are in the relatively raised or retracted position. Movement of the wheels from the relatively raised position to the relatively lowered position raises the hoist off the floor and movement of the wheels from the lowered position to the raised position lowers the hoist onto the floor to immobilise the hoist against lateral movement as there is no contact between the wheels and the floor in this configuration.

One form of the wheel arrangement 10, located at each corner of the hoist 2, will now be described. It is to be noted that the hoist is provided with four almost identical wheel arrangements, located at or towards each corner of the hoist to provide stability to the hoist whilst allowing mobility. Only one wheel arrangement will be described, the other wheels being similar if not identical, apart from some of the wheels being located as mirror images of that being described. Additionally, the wheel arrangement will be described in situ so that reference to upwards/downwards, horizontal/vertical and the like will refer to the in use position and is not meant to be limiting since this orientation of the wheel arrangement is described for ease of understanding.

Wheel arrangement 10 comprises a generally flat sided U-shaped yoke 12 which in use is fixedly connected to one end or part of lower chassis member 4 by suitable fastening means, such as for example, by being bolted to chassis member 4 or welded thereto or similar. It is to be noted that the side of yoke 12 is connected to the end of chassis member 4 for strength and to allow simplicity of construction for the adjustment mechanism of the wheel. In one embodiment yoke 12 is connected to chassis member 4 by four bolts. The substantially U-shaped yoke 12 has a web portion 14 located between two outwardly extending arm portions 16 which are arranged in spaced apart parallel relationship to each other. A substantially horizontally oriented slot 18 is centrally located in the web portion 14 for receiving tongue 20 of reinforcing member 22. A substantially circular aperture is located in each side arm 16 in alignment with one another for receiving therethrough a shaft 26 fixedly connected to operating lever 28. Movement of operating lever 28 causes the wheel arrangement to move between the raised and lowered positions as will be described in more detail later in this specification. Operating lever 28 can be connected to any suitable operating mechanism to effect operation of the wheel arrangement. One component of such mechanism is operating rod 29 which is shown in FIGS. 4 and 5. Operating rod 29 is pivotally connected to the distal end of lever 28. Movement of operating rod 29 causes corresponding movement of operating lever 28.

Each arm 16 is provided with a generally arcuate slot 30 arranged to extend substantially in alignment with a vertical axis of the arm. Slot 30 is located more towards the distal end of arm 16 than towards the proximal end. Arcuate slot 30 is positioned to bend or curve towards the distal end of arm 16. A transversely extending pin 32 is received in the aligned pair of arcuate slots 30 for movement arcuately in a generally vertical direction in response to operation of the wheeled arrangement, as will be described later. The ends of pin 32 do not substantially project from slots 30 in arms 16 but rather are substantially flush with the outer surfaces of arms 16.

Reinforcing member 22 in the form of a flat rectangular plate is provided with tongue 20 along one transverse extending side. One end of tongue 20 is received loosely in horizontal slot 18 of web portion 14 in such a manner to allow the reinforcing member to move freely during operation of the wheel arrangement 10. The other end of the reinforcing plate is fixedly connected to transversely extending pin 32 received in aligned arcuate slots 30. Pin 32 is movably connected to wheel support assembly 40 to be described in more detail later.

Returning to operating lever 28 and shaft 26, a generally elongate U-shaped bracket 34 is fixedly connected to shaft 26. Elongate bracket 34 is in general an elongated yoke shape bracket having a central web portion 36 and two side arm portions 38 in which the two side arm portions are arranged in spaced apart substantially parallel relationship to each other. The web portion 36 is fixedly connected to shaft 26 by suitable fastening means or by welding. An aperture is provided in each side arm portion 38 for receiving pin 46 in the pair of aligned apertures. As operating lever 28 is rotated elongate bracket 34 also rotates accordingly so as to move shaft 46 in a substantially upwards and downwards movement.

One form of the wheel carrying assembly 40 will now be described in detail. Wheel carrying assembly 40 includes a substantially L-shaped top plate 42 provided with a pair of downwardly depending side skirts 44 located on either side of the top plate in spaced apart substantially parallel relationship to each other. An aperture is located at or towards the distal edge of each side skirt 44. Shaft 46 is received through the aligned apertures of the side skirts 44 which are both located relatively outboard of the side arms 38 of elongate U-shaped bracket 34. Shaft 46 is securely connected to the under side of top plate 42 by strut 48. Strut 48 extends downwardly from the under side of top plate 42 and is welded thereto as well as being welded to shaft 46. The ends of shaft 46 are journalled in the aligned apertures provided in the side skirts 44 of wheel carrier assembly 40.

Top plate 42 is provided with a centrally located aperture having a circular rebated surround in the form of a counter bore located at or towards the distal end of the top surface of the top plate 42. One form of a castor wheel subassembly 50 is located on the under side of the top plate 42. Castor wheel subassembly 50 is provided with a substantially circular top plate 52 having a centrally located aperture. A nut 54 and bolt arrangement or similar is received through the aligned pair of apertures of the top plate 42 and the circular plate 52 to pivotally connect the subassembly 50 to the top plate 52. A groove (not shown) is formed in the under surface of the top plate 52 to form a ball bearing race for receiving ball bearings to assist the castor wheel subassembly swiveling and/or rotating with respect to top plate 42. A downwardly depending pair of legs 55 is connected to the under side of the circular plate 52. Each downwardly extending leg 55 is provided with an aperture. The two apertures are in alignment for receiving the axle 56 of a castor wheel 58. The circular swivel plate 52 is provided with a locking means (not shown) to lock the position of the circular swivel plate 52 with respect to the top plate 42 to prevent unwanted rotation of the castor wheel subassembly 50 with respect to the hoist. Sufficient tension or torque is applied to nut 54 holding the wheel subassembly 50 together to allow proper operation of the castor wheel subassembly. It is to be noted that castor wheel 58 is free to rotate about horizontal axle 56 as well as being free to rotate or swivel about the vertical axis containing the nut and bolt arrangement 54. This form of the wheel assembly allows the hoist to be lowered and raised by the wheels being raised (retracted) and lowered (extended) repectively.

An alternative form of the castor wheel assembly, denoted generally as 60, will now be described with reference to FIGS. 11 to 13. In this form of castor wheel assembly 60, there is provided a fixed or stationary framework member 62 which is fixedly secured to the remainder of the wheel assembly in a similar manner to the method of fixing top plate 42 of the previously described wheel assembly 50 to the remainder of the wheel arrangement. Fixed frame member 62 is in the form of a U-shaped bracket or yoke and comprises a top deck 64 having a generally curved perimeter portion 66 located between two straight side portions 68a, b. A pair of opposed facing substantially parallel substantially triangular side skirts 70 depend downwardly from deck 64 for attachment to the remainder of the wheel assembly, such as shaft 46 and pin 32 to effect raising and lowering of the wheel assembly 60 in the same or similar manner to that described previously with respect to wheel assembly 50.

A circular aperture 65 is provided centrally in deck 64. The perimeter of the circular aperture is formed as a flanged or rebated section 73 forming a track or race around the circumference of the aperture in which a first set of substantially horizontally mounted travel means in the form of roller bearings are free to travel in accordance with rotation of the wheel assembly 60, as will be described in more detail below.

Wheel assembly 60 further includes a mounting means in the form of a substantially U-shaped bracket or yoke 72 including a circular top plate 74 and a pair of spaced apart downward depending substantially triangular support arms 76, 78. The distal end of each support arm 76, 78 is provided with an aperture (not shown) for receiving either end of an axle 80 received through the central axis of floor contacting wheel 82 for pivotal mounting of wheel 82, the wheel assembly in use. In use, wheel 82 is free to rotate about axle 80 to move hoist 2 from one position to another position. Wheel 82 can take any suitable shape, size or configuration depending on needs. Further, wheel 82 can be made from any suitable material, including hard wearing, tough and durable plastics material or the like. In one particular form, wheel 82 is made from a slightly resilient material and is of a width to provide sufficient support for a heavy motor vehicle.

A further embodiment of the wheel assembly 60 which is not shown in the drawings includes a ring having a gap or space by removing a part of the circumference of the ring. Wheel 82 can rotate partially in the gap or space. The pair of spaced apart downwardly depending substantially triangular support arms are inclined to one side and are secured to the sides of the gap or space in the ring. Axle 80 is supported by the two inclined support arms to allow wheel 82 to rotate partially in the gap or space provided in the ring. In this embodiment, the height of the mounting means for the wheel is only slightly higher than the top of wheel 82 resulting in a very compact wheel arrangement allowing the hoist in a lower configuration to fit under a motor vehicle when supported by its road wheels. In this embodiment, the roller bearings are located below the top of the wheels, not at or above the top of the wheel as shown in FIG. 11 or 12.

The web of yoke 72 in the form of a circular top plate 74 is provided with six substantially vertically mounted roller bearings 86 acting as the second set of travel means or similar located at more or less regularly spaced apart locations around the underside in use of the perimeter of the top plate. However, it is to be noted that the six roller bearings 86 may be mounted in any suitable pattern or arrangement. One preferred arrangement, as shown more particularly in FIG. 12, is having three spaced apart roller bearings 86a, b, c associated with one side of plate 74, such as for example, associated with one support arm 76 and another three spaces apart roller bearings 86d, e, f associated with the other support arm 78. One set of roller bearing 86a, b, c is spaced apart from the other set of roller bearings 8d, e, f are located at or towards either edge of arm 76 and at about the mid point of arm 76 on one side, whereas on the other side of plate 74 roller bearings 86d, e, f are located at or towards either edge of arm 78 and at about the mid point of arm 78. However, it is to be noted that any suitable or convenient arrangement may be used. It is also to be noted that rollers 86 travel around the underside of the edge of aperture 65 in use to allow the mounting means and wheel 82 to rotate in unison with respect to the stationary member.

Roller bearings 86 are journalled for rotation about stub axles 88 extending outwardly from blocks 90, fixedly secured to the underside of circular plate 74 at spaced apart intervals corresponding to the spacing of the roller bearings. One form of block 90 is hexagonal, as shown in FIGS. 11 to 13. However, other forms of block 90 are possible. Roller bearings 86 are mounted to run around a circular path around the peripheral edge of the aperture 65 provided in the underside of deck 64 in accordance with the swivelling movement of this subassembly.

On the upper surface in use of plate 74 is provided a first set of travel means in the form of seven substantially horizontally mounted roller bearings 96 located at more or less regularly spaced apart locations around the circumference of circular plate 74. In one embodiment, six of the seven roller bearings 96 are located in alignment with roller bearings 86 such that there are six pairs of roller bearings 86a, 96a; 86b, 96b; and so on to 86f, 96f. The seventh roller bearing 96g is located between roller bearings 96c and 96d near the respective side supports 76, 78. Roller bearings 96 are journalled on axles 98 extending upwardly from plate 74. Roller bearings 96 are positioned so as to travel in a race or track formed by the flanged rebate 73 and thus describe a circular path around the edge of aperture 65 as shown more particularly in FIG. 12. It is to be noted that the combination of roller 86 and 96 acting against their respective tracks keep the yoke 72 in place. It is to be noted that there can be any number of roller bearings 86 and any number of roller bearings 96. Typically, there are four roller bearings 96 located at spaced apart locations. Further, it is to be noted that any sizes and types of roller bearings can be used in different embodiments of the invention depending upon requirements, including roller bearings 96 being of a different size and type to roller bearings 86.

A substantially circular cover plate 92 is securely fastened to top plate 74 by suitable fasteners, such as bolts 100 having a counter sunk head 102. In one embodiment, the shanks of bolts 100 serve as the axles for roller bearings 96 as shown in the cross-section portion of FIG. 13.

Bolts 100 secure cover plate 98 to top plate 74. A lock means (not shown) is optionally provided to lock the swivelling assembly with respect to the fixed framework member if required.

The six substantially vertical roller bearings 86 contact the under surface of plate 74 adjacent the edge of the aperture 65 so that the under surface edge forms a race or track around which the six roller bearings 86 travel in accordance with swivelling movement of plate 74. Thus, deck 64 and side skirts 70 are fixedly connected to the remainder of the wheel assembly and the combination of the wheel 92, top plate 74, and cover plate 92 all rotate as a single unit in unison with respect to the fixed deck 64 when the wheel 82 is to rotate through 360° to provide sideways movement of the hoist. The combination of the horizontally aligned seven roller bearings 96 and the six substantially vertically aligned roller bearings 86 allow for rotational movement of the wheel 82 with respect to the fixed deck 64, whilst providing the strength necessary to support a load on the hoist, which has four similar wheel assemblies 60 mounted at the corners of the hoist.

An alternative form of the raising and lowering mechanism for moving the wheel assembly 60 of the embodiment shown in FIGS. 11 to 13 will now be described. This alternative arrangement is not illustrated in the drawings. However, the alternative mechanism can be connected to the embodiment shown in FIGS. 11 to 13 and accordingly will be described in association with this embodiment. In this alternative arrangement there is provided a tubular round shaft having a yoke arrangement attached thereto. The distal end of the yoke arrangement is connected to an operating rod corresponding to operating rod 29 of the embodiment of FIGS. 1 to 10, for operation by a suitable operating lever (similar to operating lever 28) or the like. Movement of the operating rod causes rotational movement of the shaft. A second yoke arrangement is fixedly connected to the shaft adjacent the first yoke arrangement for corresponding movement in accordance with rotary movement of the shaft. The distal end of the second yoke arrangement is provided with a pair of spaced apart apertures located in register with each other. A connecting pin is received through the pair of aligned apertures for connection to the alternative wheel form of the assembly 60. The connecting pin is also received through an aperture provided in downwardly extending side skirt 70 of the wheel assembly 60.

As operating rod 29 moves so also does the first yoke arrangement which in turn causes rotation of the shaft. Rotation of the shaft causes movement of the second yoke arrangement which in turn causes arcuate movement of the connecting pin. As the connecting pin is connected to the side skirt 70 of the wheel assembly 60 movement of the connecting pin causes the side skirt to move vertically. This alternative mechanism which in effect is a parallelogram linkage allows substantially vertical movement of the side skirts 70 as the shaft rotates owing to the presence of the parallel linkage between the top of the wheel assembly 60 such as for example the top deck on the one hand and between the side skirt 70 and the base of the hoist on the other hand. It is to be noted that the parallel linkage ensures that the hoist, particularly the support platform, remains parallel to floor 8 at all times.

It is to be noted that four such alternative raising and lowering mechanisms are provided on the hoist one associated with each wheel so that all four wheels can be adjusted simultaneously and in unison whilst keeping the load in a stable condition parallel to the floor at all times, thereby providing one of the advantages of the hoist of the present invention.

Further, it is to be noted that owing to the wheel assembly and the raising and lowering mechanism for the wheel assembly the diameter of wheel 82 can be made almost as large as the distance between the ground or floor upon which the hoist rests and the height of the hoist. The ability to provide larger sized wheels in the wheel assembly results in the wheel assembly being stronger and more robust as well as providing better flexibility and manoeuvrability of the hoist. The fitting of the larger diameter wheels enables the hoist to be able to carry heavier loads, to be more durable, be safer in operation and the like.

Returning now to FIGS. 1 to 10, operation of the wheel adjustment device or arrangement 10 of one form of the hoist of the present invention will now be described. With the hoist 2 in the lowered position, as shown in FIG. 2, with chassis member 4 resting upon floor 8, that is with the wheels 58 in the relatively raised or retracted position, as shown in FIG. 2, operating lever 28 is in the substantially vertical position as shown in FIG. 5 and operating rod 29 is in the substantially relatively raised horizontal position. Operating lever 28 is caused to rotate clockwise through about 90 degrees by corresponding movement of operating rod 29 which remains substantially horizontally but now in a relatively lowered position, so that in turn shaft 26 rotates clockwise in the aligned pair of apertures provided in side arms 16 through about 90 degrees also. Simultaneously, elongate bracket 34 rotates clockwise through about 90 degrees accordingly which in turn forces strut 48 generally arcuately downwards thus lowering wheel assembly 50 simultaneously with causing connecting pin 32 to move arcuately clockwise downwardly within slot 30 from the relatively upwards position as shown in FIGS. 5, 7 and 9 to a relatively downwards position as shown in FIGS. 4, 6 and 8. Owing to pin 32 being fixedly connected to one end of reinforcing plate 22, as pin 32 moves the end of reinforcing plate 22 rotates downwardly to adopt a generally downwardly inclined position as shown in FIG. 8. Reinforcing plate 22 is free to rotate as tongue 20 is received loosely within horizontal slot 18 thus allowing it to move. As the ends of pin 32 extend through slots 30 the extent of movement of pin 32 is limited by the ends of the pin contacting the ends of the slot. This in turn limits the movement of subassembly 40 and of wheel 58. When reinforcing plate 22 is in the lower position it provides reinforcement for and additional strength to assembly 40 by providing additional strength to support heavy loads on upper platform 6 of hoist 2.

Shaft 46 is fixedly connected to strut 48 which in turn is fixedly connected to the under side of top plate 42 so that when elongate bracket 34 rotates clockwise downwardly strut 48 and shaft 46 also move downwardly forcing plate 42 to move downwardly which in turn causes the wheel 58 to move downwardly initially contacting floor 8 and then further movement of wheel 58 causes chassis member 4 to rise since wheel 58 cannot go lower than floor 8, which has the effect of raising chassis member 4 and hoist 2 off floor 8 since the hoist is now supported on wheel 58.

When the wheel 58 adopts the position as shown in FIGS. 4, 6 and 8, which is the lowered or extended position of the wheel, chassis member 4 is raised above the level of floor 8 as shown in FIG. 1 enabling the hoist to be moved over the floor surface by wheels 58 rotating about axle 56 and swiveling about top plate 42.

In the embodiment having the wheel arrangement of FIGS. 11 to 13, when the hoist 2 is in the raised position and the wheel 82 is in contact with the floor of the workshop or similar, the hoist is moved in the desired direction by pushing or pulling on the side of the hoist. The sideways movement on the hoist causes the castor wheel 82 to swivel so as to track in the desired direction. The castor wheel 82 is allowed to swivel by operation of the vertical roller bearings 86 and the horizontal roller bearings 96 travelling in their respective tracks or races. The substantially vertical roller bearings 86 are held in contact with the lower surface in use of the deck 64 by the clamping force between the top plate 74 and cover 92 located on either side of the deck due to the tension applied by bolts 100. The substantially horizontally arranged roller bearings 96 travel in the flanged rebate 73 around the circumference of the aperture 65 and are held in place by the cover 92 being clamped to the deck 64 by bolts 100. This arrangement allows complete freedom of swivelling motion through 360° whilst also providing a strong and secure connection for the wheel 82 to the hoist 2, enabling the hoist to carry a considerable load whilst providing maximum flexibility of movement and strength.

Returning now to the embodiment of FIGS. 1 to 10, when the hoist is located in the final position the wheel arrangement 10 is adjusted to retract wheel 58 and lower chassis member 4 onto floor 8. This is accomplished by moving operating rod 29 to move operating lever 28 from a substantially horizontal position, as shown in FIG. 4, to a substantially vertical position as shown in FIG. 5. Rotation of operating lever 28 in the anti-clockwise position causes elongate bracket 34 to also rotate upwardly in an anti-clockwise direction which in turn forces strut 48 in an upwards position which forces side skirts 44 in an upwards direction which causes connecting pin 32 in an upwards direction as well as top plate 42 and thus wheel assembly 40. Simultaneously with this movement transversely extending pin 32 rotates upwardly anti-clockwise within slot 30 so that reinforcing plate 22 raises together with the wheel carrying subassembly 40. When lever 28 is in the fully extended position, ie substantially vertically, the wheel carrying subassembly 40 is in the fully raised position which in effect retracts the wheel 58 within the hoist 2 to adopt a position as shown in FIG. 2 wherein chassis member 4 rests upon floor surface 8 thereby preventing unwanted movement of the hoist which provides stability for the load on the hoist when in this storage position.

Advantages of the present invention include that the wheel assembly is compact, strong and able to easily move from one configuration to another.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1. A wheel arrangement having a first support arrangement, a second support arrangement, a fixed framework member and a moveable support having a substrate contacting wheel, characterised in that said first and second support arrangements are moveable with respect to the fixed framework member, the first support arrangement and the second support arrangement are located substantially tranversely to each other, and cooperatively interact with the fixed framework member whilst permitting the moveable support member to move with respect to the fixed framework member, so that movement of the first and second support arrangements permits the substrate contacting wheel to move with respect to the fixed framework member.

2. A wheel arrangement, characterised in that the arrangement includes a fixed member provided with a first pathway and with a second pathway, a mounting member or means provided with a wheel moveable with respect to the mounting means, said mounting means provided with a first travel means for movement along the first pathway of the fixed member, and a second travel means for movement along the second pathway of the fixed member, said mounting means and wheel being moveable as a unit with respect to the fixed member, wherein the first travel means and the second travel means are arranged to lie in two different planes so that movement of the first travel means along the first pathway and movement of the second travel means along the second pathway are in unison with each other, so as to facilitate movement of the mounting means with respect to the fixed member, thereby allowing the wheel to move with respect to the fixed member, whilst allowing the first and second travel means to remain in contact with the fixed member.

3. A wheel arrangement including:
an operating member moveable between a first position and a second position;
a wheel carrying assembly moveable between a first position and a second position; and
a reinforcing member connected to the wheel carrying assembly, characterised in that movement of the operating member in one direction causes corresponding movement of the wheel carrying assembly and reinforcing member in a first direction so that the wheel carrying assembly adopts a first position, and movement of the operating member in another direction causes corresponding movement of the wheel carrying assembly and the reinforcing member in a second direction to adopt a second position, whereby the reinforcing member limits the amount of movement in the first and second directions between the first and second positions and determines the first and second positions whilst assisting in maintaining the wheel carrying assembly in the first and in the second positions, so that in one position the wheel arrangement contacts a substrate upon which a load borne by the wheel assembly is supported, and in another position the wheel arrangement is not the sole support of the load on the substrate.

4. A wheel arrangement according to claim 3, characterised in that the operating member is an operating lever.

5. A wheel arrangement according to claim 4, characterised in that the operating lever is fixedly connected to a rotating shaft.

6. A wheel arrangement according to claim 4, characterised in that the operating lever rotates in a first direction to lower the wheel arrangement and rotates in a second direction to raise the wheel arrangement.

7. A wheel arrangement according to claim 3, characterised in that the wheel carrying assembly includes a wheel carrying member to which the operating member is connected.

8. A wheel arrangement according to claim 7, characterised in that the wheel carrying member is a shaft, axle, pin or similar.

9. A wheel arrangement according to claim 3, in which the wheel carrying assembly is a castor wheel assembly.

10. A wheel arrangement according to claim 1, characterised in that the first support arrangement includes a roller means and the second support arrangement includes a roller means.

11. A wheel arrangement according to claim 10, characterised in that the roller means includes a roller wheel, roller bearings or similar allowing swivelling movement of the ground contacting wheel assembly with respect to the remainder of the wheel carrying assembly.

12. A wheel arrangement according to claim 9, characterised in that the wheel carrying assembly is moveable between a first position in which the castor wheel is in a relatively lowered position or an extended position, and a second position in which the castor wheel is in a relatively raised position or retracted position.

13. A wheel arrangement according to claim 3, characterised in that the reinforcing member is a plate having a hinge member, preferably a tongue.

14. A wheel arrangement according to claim 1, characterised in that the wheel arrangement is provided with a main framework member which is fixedly connected at one side to the end of a lengthwise extending member by suitable fastening means.

15. A wheel arrangement according to claim 7, characterised in that the wheel assembly is fixedly connected to the wheel carrying member.

16. A wheel arrangement according to any preceding claim claim 2, characterised in that the fixed member is substantially U-shaped bracket or yoke fixedly connected to the wheel carrying member for movement therewith to move the wheel assembly between two different configurations.

17. A wheel arrangement according to claim 2, characterised in that there is a U-shaped bracket or yoke including a deck and two downwardly depending side support arms or side skirts.

18. A wheel arrangement according to claim 7, characterised in that the wheel arrangement further includes side support arms or side skirts which are connected to the wheel carrying member.

19. A wheel arrangement according to claim 17, characterised in that the deck is provided with a central aperture.

20. A wheel arrangement according to claim 19, characterised in that the central aperture is provided with a flanged edge or rebated edge around the circumference of the aperture.

21. A wheel arrangement according to claim 20, characterised in that the flanged or rebated edge is the first pathway which forms a substantially circular track or race for receiving a runner or similar.

22. A wheel arrangement according to claim 19, characterised in that the circular aperture of the deck is provided with an undersurface adjacent the circumference of the aperture which forms the second pathway.

23. A wheel arrangement according to claim 2, characterised in that the second pathway is a race or track for receiving a traveller or runner, preferably a different traveller or runner than in contact with the first pathway.

24. A wheel arrangement according to claim 2, characterised in that the mounting member or means is a substantially U-shaped bracket or yoke having a web portion and two downwardly depending side arms or support arms.

25. A wheel arrangement according to claim 24, characterised in that the side arms are substantially triangular in shape.

26. A wheel arrangement according to claim 2, characterised in that the first travel means includes roller means, such as roller wheels, roller bearings, ball bearings or similar.

27. A wheel arrangement according to claim 1, characterised in that the first support arrangement is one or more roller wheels, said roller wheel or wheels being mounted substantially horizontally.

28. A wheel arrangement according to claim 27, characterised in that the roller wheels of the first support arrangement rotate within the flanged rebate around the circumference of the aperture in the deck.

29. A wheel arrangement according to claim 27, characterised in that there are seven roller wheels forming the first support arrangement.

30. A wheel arrangement according to claim 2, characterised in that the second travel means includes roller means, such as roller wheels, roller bearings, ball bearings or similar which are mounted substantially vertical for travelling around the edge of the aperture along the underside of the deck.

31. A wheel arrangement according to claim 1, characterised in that there are from two to seven individual roller wheels forming the second support arrangement.

32. A wheel arrangement according to claim 24, characterised in that the mounting means is provided with a cover for releasably securing to the web of the U-shaped bracket forming the mounting means.

33. A wheel arrangement according to claim 32, characterised in that the cover plate is located on one side of the deck of the fixed member, preferably the upper side in use, whilst the web of the mounting means is located at the other side of the deck, preferably the underside of the deck.

34. A wheel arrangement according to claim 33, in which the cover plate is clamped to the mounting means to locate and maintain the two sets of roller wheels in the respective tracks so as to allow the mounting means and wheels to rotate or swivel with respect to the fixed member, thereby permitting 360 movement of the substrate contacting wheel.

35. A wheel arrangement according to claim 34, characterised in that the position of the first set of roller wheels substantially corresponds to the position of the second set of roller wheels.

36. A wheel arrangement according to claim 34, characterised in that the fasteners used to fasten the first set of roller wheels is also used to fasten the cover plate.

37. A wheel arrangement according to claim 2, characterised in that the mounting member includes a tubular member having a space or gap in the side wall.

38. A wheel arrangement according to claim 2, characterised in that the mounting member is a ring from which a section of the side wall has been removed.

39. A wheel arrangement according to claim 37, characterised in that the wheel rotates at least partially in the gap or space so as to reduce the height of the wheel arrangement.

40. A wheel arrangement according to claim 33, characterised in that the majority of the mounting means is located below the top of the wheel preferably, the roller wheels are located below the top of the wheel to result in a more compact wheel arrangement.

41. A hoist having a wheel arrangement including: an operating member moveable between a first position and a second position; a wheel carrying assembly moveable between a first position and a second position; and a reinforcing member connected to the wheel carrying assembly, characterised in that movement of the operating member in one direction causes corresponding movement of the wheel carrying assembly and reinforcing member in a first direction so that the wheel carrying assembly adopts a first position, and movement of the operating member in another direction causes corresponding movement of the wheel carrying assembly and the reinforcing member in a second direction to adopt a second position, whereby the reinforcing member limits the amount of movement in the first and second directions between the first and second positions and determines the first and second positions whilst assisting in maintaining the wheel carrying assembly in the first and in the second positions, so that in one position the wheel arrangement contacts a substrate upon which a load borne by the wheel assembly is supported, and in another position the wheel arrangement is not the sole support of the load on the substrate.

42. A hoist according to claim 41, characterised in that there are four substantially identical wheel arrangements located at or towards the four corners of the hoist.

43. (canceled)

44. (canceled)
